(19) United States
(12) Patent Application Publication
(10) Pub. No.: US 2025/0278589 A1
(43) Pub. Date: Sep. 4, 2025

(54) SMEARING APPARATUS

(71) Applicant: Sysmex Corporation, Kobe-shi (JP)

(72) Inventors: Tetsunori Hatase, Kobe-shi (JP); Takaaki Nagai, Kobe-shi (JP); Seiya Shinabe, Kobe-shi (JP); Mitsuo Yamasaki, Kobe-shi (JP); Masaharu Shibata, Kobe-shi (JP)

(21) Appl. No.: 19/060,471

(22) Filed: Feb. 21, 2025

(30) Foreign Application Priority Data
Feb. 29, 2024 (JP) 2024-030840

(51) Int. Cl. G06K 15/02; G01N 35/00; G02B 21/34; G06K 15/00

(52) U.S. Cl. CPC G06K 15/023; G01N 35/00029; G01N 35/00732; G06K 15/028; G06K 15/408; G01N 2035/00138; G01N 2035/00772; G01N 2035/00831; G02B 21/34

(57) ABSTRACT

Disclosed is a smearing apparatus including a printer configured to print the machine-readable code on the slide glass to achieve both the continuation of smear specimen preparation and the identification of the slide glass. The smearing apparatus obtains, by the controller of the smearing apparatus, information regarding an availability of the machine-readable code printed by the printer, and performs, by the controller, a first control of printing the machine-readable code on the slide glass by the printer, or a second control different from the first control.

### RELATED APPLICATIONS

This application claims priority to Japanese Patent Application No. 2024-030840, filed on Feb. 29, 2024, entitled “CONTROL METHOD OF SMEAR PROCESSOR AND SMEAR PROCESSOR”, the entire content of which is incorporated herein by reference.

### BACKGROUND OF THE INVENTION

### 1. Field of the Invention

The present disclosure relates to a smearing apparatus and method to control thereof.

### 2. Description of the Related Art

As a smear specimen processing apparatus, for example, a smearing apparatus that smears a specimen on a slide glass to produce a smear specimen is known. Japanese Laid-Open Patent Publication No. 2017-198635 discloses a smearing apparatus in which a printer prints specimen number, date, bar code, two-dimensional code, or the like in a printing area of a slide glass.

### SUMMARY OF THE INVENTION

A thermal printer is used as a printer to print on a slide glass. The heating element of the thermal printer may be broken due to continuous use. If some heating elements of the thermal printer are broken, part of the printing will be missing. For example, a missing of a part of the printing of the patient's name or the sample number may result in altering the entire printed text, and the laboratory technician may not be able to identify the slide glass. In the conventional smearing apparatus, even a few breakages in the printer can disrupt the processing of the smearing of specimen. During the disruption of the smear processing, preparation of new smear specimen must have been interrupted.

The present invention aims to achieve both the continuation of smear preparation and the identification of a slide glass.

A first aspect of the present invention is a smearing apparatus, comprising: a printer configured to print a machine-readable code used for identification of a specimen onto a slide glass; a smearing unit configured to smear the specimen on the slide glass; and a controller programmed to obtain information indicating an availability of the printer, and to perform, based on the information, a first control to control the printer to print the machine-readable code on the slide glass, or a second control to suspend the printer.

### BRIEF DESCRIPTION OF THE DRAWINGS

FIG. 1 is a perspective view of a smearing apparatus, which is an example of a smear slide processing system.

FIGS. 2A and 2B show an example of a slide glass.

FIG. 3 shows an example of a smear slide processing system configured by a plurality of smear specimen processing apparatuses.

FIG. 4 shows an example of a block diagram of a smearing apparatus.

FIGS. 5A, 5B and 5C show an example of a configuration of a thermal printer.

FIGS. 6A, 6B and 6C show an example of a process of printing the machine-readable code and the text information.

FIGS. 7A and 7B show an example of a result of printing a machine-readable code.

FIGS. 8C, 8D, 8E and 8F show an example of a result of printing a machine-readable code.

FIG. 9G shows an example of a result of printing the machine-readable code and the characters.

FIG. 10 is a flowchart showing an example of a flow of determination processing performed by the controller in the first example.

FIG. 11A shows an example of the first mode of the print modes.

FIG. 11B shows an example of the second mode of the print modes.

FIG. 12A shows an example of the first mode of the print modes.

FIG. 12B shows an example of the second mode of the print modes.

FIG. 13A shows an example of the first mode of the print modes.

FIG. 13B shows an example of the second mode of the print modes.

FIG. 14 shows an example of the condition setting data stored in the storage.

FIG. 15 shows an example of a condition setting screen displayed on the display unit.

FIG. 16 is flowchart showing an example of a flow of determination processing performed by a controller in a modification of the first embodiment.

FIG. 17A shows an example of the first mode in a case where multiple machine-readable codes are printed.

FIG. 17B shows an example of the second mode in a case where multiple machine-readable codes are printed.

FIG. 18 shows an example in which a reader is provided in a slide transport apparatus capable of communicating with the smearing apparatus.

FIG. 19 shows an example in which a reader is provided in a imaging apparatus capable of communicating with the smearing apparatus.

### DETAILED DESCRIPTION OF THE PREFERRED EMBODIMENTS

The smearing apparatus according to an exemplary embodiment of the present invention will be described with reference to the drawings.

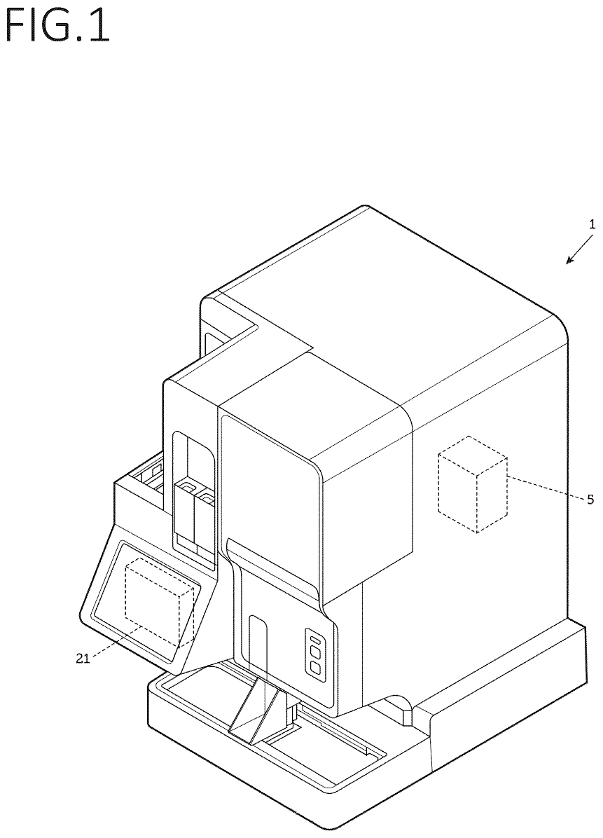

FIG. 1 shows a perspective view of a smearing apparatus 1 which is an example of a smear specimen processing apparatus. The smearing apparatus 1 is an apparatus that smears a specimen on a slide glass to prepare smear specimens. The smearing apparatus 1 includes a controller 21 as described later. The smearing apparatus also includes a printer 5.

In the following embodiment, the smearing apparatus 1 will be described as an example of the smear specimen processing apparatus. The smearing apparatus to which the present invention is applicable is not limited to the smearing apparatus 1. The present invention may be applied to a slide transport apparatus 100 configured with a printer, or a imaging apparatus 200 configured with a printer. The slide transport apparatus 100 and the imaging apparatus 200 will be described later.

### Example 1

### (Slide Glass SG)

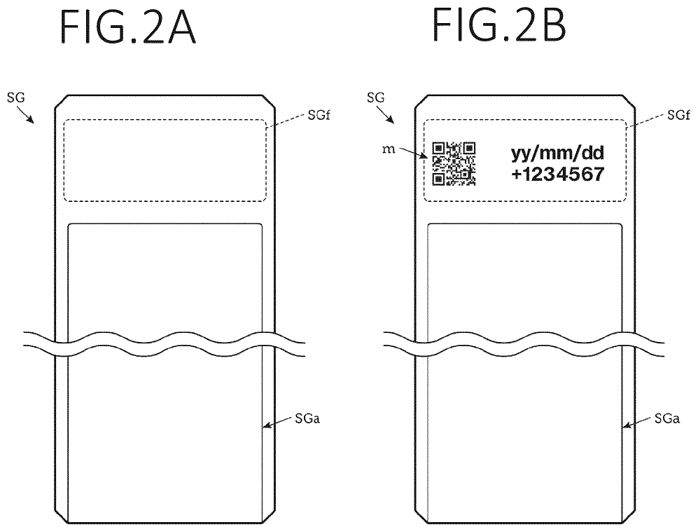

FIGS. 2A and 2B show an example of the slide glass SG. The slide glass SG is made of a rectangular glass plate material. A specimen is smeared on a smearing area SGa in the center. At the upper end, a printing area SGf is provided at one longitudinal end of the slide glass SG. The printing area SGf is a printing area of a machine-readable code m described later. The printing area SGf is, for example, an area processed by frosting the glass surface so as to enable a printing thereon. The printing area SGf may also be an area that has been treated to enable printing by coating a glass surface with a synthetic resin or the like. The machine-readable code m is information for identifying a specimen and is printed on the printing area SGf in the form of a two-dimensional code such as a QR code (registered trademark), a data matrix, a one-dimensional code such as a bar code, or the like. Text information such as a specimen number, a date, and a patient name may be printed on the printing area SGf in addition to the machine-readable code m.

### (Smear Specimen Processing System)

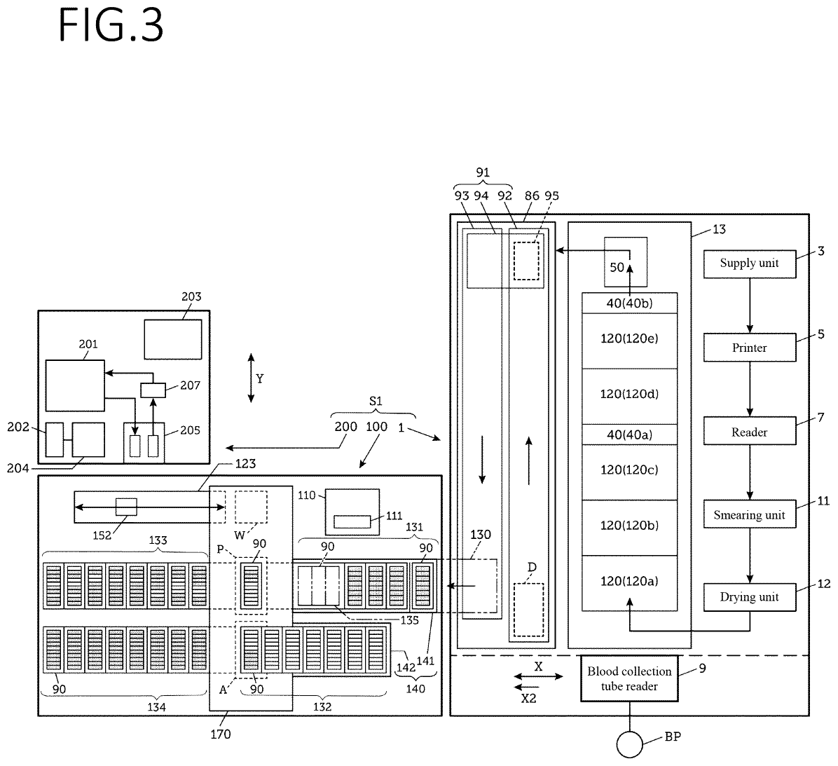

Hereinafter, an example of the smear slide processing system S1 configured by a plurality of smear specimen processing apparatuses will be described with reference to FIG. 3. The smear slide processing system S1 includes a smearing apparatus 1, a slide transport apparatus 100, and a imaging apparatus 200. The smear specimen produced by the smearing apparatus 1 and supplied to the slide transport apparatus 100 is supplied to the imaging apparatus 200 by the slide transport apparatus 100. The smear slide processing system S1 can automatically perform, by the smearing apparatus 1, the smear transport apparatus 100, and the imaging apparatus 200, a series of operations from preparation of a smear specimen, in which a specimen such as blood is smeared on the slide glass SG, to imaging of the smear specimen.

### (Smearing Apparatus 1)

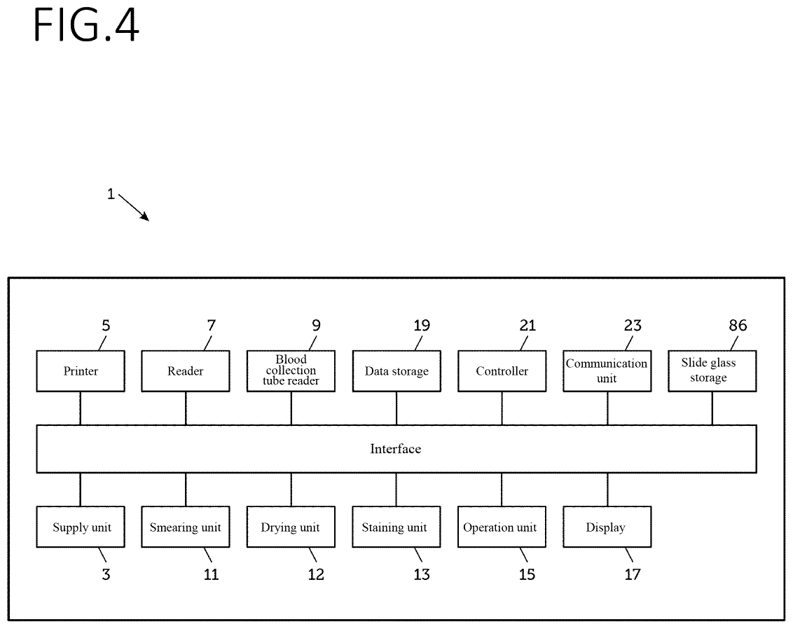

The smearing apparatus 1 shown in FIG. 4 is an apparatus that produces a smear specimen by smearing a specimen, such as blood from a subject, onto a slide glass SG and then performing processes such as drying and staining. A detailed configuration of the smearing apparatus 1 will be described later.

### (Smear Specimen Transport Apparatus 100)

The slide transport apparatus 100 receives the slide glasses SG that has been stained from the smearing apparatus 1, sorts the slide glasses SG into slide glasses SG to be imaged by the imaging apparatus 200 and slide glasses SG not to be imaged by the imaging apparatus 200, and supplies the slide glasses SG to be imaged to the imaging apparatus 200. As shown in FIG. 3, the slide transport apparatus 100 includes a controller 110 that controls various units of the slide transport apparatus 100, a communication unit 111 that communicates with the smearing apparatus 1 and the imaging apparatus 200, and the like.

The slide transport apparatus 100 has a first supply area 131 to supply a magazine 90, which is a specimen container containing the slide glasses SG that has been stained, and a second supply area 132 to supply an empty magazine 90 set by the user. The slide transport apparatus 100 has a first storage area 133 to exclusively store the slide glasses SG that are not an imaging target (i.e., the slide glass SG to be manually examined by microscope) after the slide glasses SG to be imaged are picked up. The slide transport apparatus 100 has a second storage area 134 to store the slide glasses SG that are imaged as an imaging target. An interrupt slide carrier set area 135, where magazines 90 containing slide glasses SG prepared by the user are set, may be provided on the left side of the first supply area 131.

The slide transport apparatus 100 includes a slide carrier transport unit 140 that transports the supplied slide glasses SG, and a slide transfer unit 170 that stores the slide glasses SG to be imaged in the transport case 152 and transfers the slide glasses SG to the imaging apparatus 200. The slide carrier transport unit 140 includes a first transport unit 141 and a second transport unit 142. The first transport unit 141 and the second transport unit 142 transport the magazines 90 in the X2 direction. The slide transport apparatus 100 includes a horizontal movement mechanism 123 that moves the slide glasses SG between the slide transfer position W and the transfer unit 205 of the imaging apparatus 200. The first supply area 131 and the first storage area 133 belong to the first transport unit 141. The second supply area 132 and the second storage area 134 belong to the second transport unit 142.

The first transport unit 141 receives the magazine 90 from the smearing apparatus 1 and transports the magazine 90 from the first supply area 131 to the slide pickup position P. At the slide pickup position P, the slide glasses SG are sequentially picked up by a handling unit (unillustrated) of the slide transfer unit 170, and are sorted into slide glasses SG to be imaged and slide glasses SG not to be imaged. The sorting is performed, for example, by reading the machine-readable code m with a reader (e.g., a camera, a bar code reader) (unillustrated) and inquiring to the data storage 19 about the necessity of imaging. The magazine 90 carrying the slide glasses SG that are not to be imaged are transported from the slide pickup position P to the first storage area 133. These slide glasses SG will be subjected to visual inspection by a microscope. The slide glasses SG to be imaged are inserted into the transport case 152 at the slide transfer position W, and the transport case 152 is positioned at the transfer part 205 of the imaging apparatus 200.

The second transport unit 142 transports the empty magazine 90 set in the second supply area 132 by the user to the slide storage position A. The slide glasses SG that has been imaged by the imaging apparatus 200 at the slide storage position A is sequentially stored in the magazine 90. When the magazine 90 at the slide storage position A becomes full, the second transport unit 142 transports the full magazine 90 from the slide storage position A to the second storage area 134. Thereafter, the magazine 90 in the empty state is transported to the slide storage position A by the second transport unit 142.

### (Smear Specimen Imaging Apparatus 200)

The imaging apparatus 200 is an apparatus that receives the slide glasses SG, determined to be imaged, from the slide transport apparatus 100 and images those slide glasses SG. The imaging apparatus 200 includes, as shown in FIG. 3, a controller 202 that controls various units of the imaging apparatus 200 and a communication unit 204 that performs communication with the smearing apparatus 1 and the slide transport apparatus 100. In the imaging apparatus 200, the slide glass SG is taken out from the transport case 152 which has moved to the transfer unit 205. The taken-out slide glass SG is transported to the oil applicator 207. Oil is applied to the specimen such as blood smeared on the slide glass SG at the oil applicator 207 as necessary. The imaging apparatus 200 identifies the specimen by reading the machine-readable code m printed on the slide glass SG with a reader (unillustrated). Next, the slide glass SG is transported to the imaging unit 201 by a transport unit (unillustrated). In the imaging unit 201, an image of the specimen is captured by a camera. The captured image data is transmitted to the controller 202. The controller 202 performs predetermined processing such as feature extraction processing and identification/classification of cells, trimming of blood cell images, automatic classification of blood cells, and counting cells for each of blood cell types. The captured image data and the analysis result can be displayed on the monitor 203 together with the information decoded from the read machine-readable code. The captured image data can also be transmitted to another apparatus via the communication unit 204.

The captured slide glass SG is returned to the transfer unit 205 by a transport unit (unillustrated) and returned to the waiting transport case 152. The transport case 152 is moved to the slide transfer position W and is reoriented from the horizontal posture to the upright posture by a posture change mechanism (unillustrated). The slide glass SG in the transport case 152 placed in the upright position at the slide transfer position W is picked up by a handling unit (unillustrated) and stored in the magazine 90 waiting at the slide storage position A. As such, the magazine 90 waiting at the slide storage position A stores the imaged slide glasses SG. The configuration of the specimen transport apparatus described in U.S. Patent Application Publication No. 2018/0031588 can be applied as the smear specimen transport apparatus 100 for example. The configuration of the specimen image imaging apparatus described in U.S. Patent Application Publication No. 2018/0031588 can be applied as the slide transport apparatus 100 for example. U.S. Patent Application Publication No. 2018/0031588 is incorporated herein by reference.

### (Detailed Configuration of the Smearing Apparatus 1)

FIG. 4 shows an example of a block diagram of the smearing apparatus 1. The smearing apparatus 1 includes a supply unit 3, a printer 5, a reader 7, a blood collection tube reader 9, a smearing unit 11, a drying unit 12, a staining unit 13, an input unit 15, a display 17, a data storage 19, a controller 21, a communication unit 23, and a slide glass storage 86, and each unit is communicably connected via an interface. Hereinafter, components of an embodiment of the smearing apparatus 1 will be specifically described mainly with FIG. 3.

### (Supply Unit 3)

The supply unit 3 has a function of supplying the pre-processed slide glasses SG. For example, the supply unit 3 stores a plurality of slide glasses SG and transfers the slide glasses SG one by one to the transport mechanism. The slide glass SG supplied to the transport mechanism is transported by the transport mechanism to the printer 5, the reader 7, the smearing unit 11, and the drying unit 12. The transport mechanism described in U.S. Patent Application Publication No. 2017/0315030 can be applied as the transport mechanism of the present embodiment, for example. U.S. Patent Application Publication No. 2017/0315030 is incorporated herein by reference.

### (Printer 5)

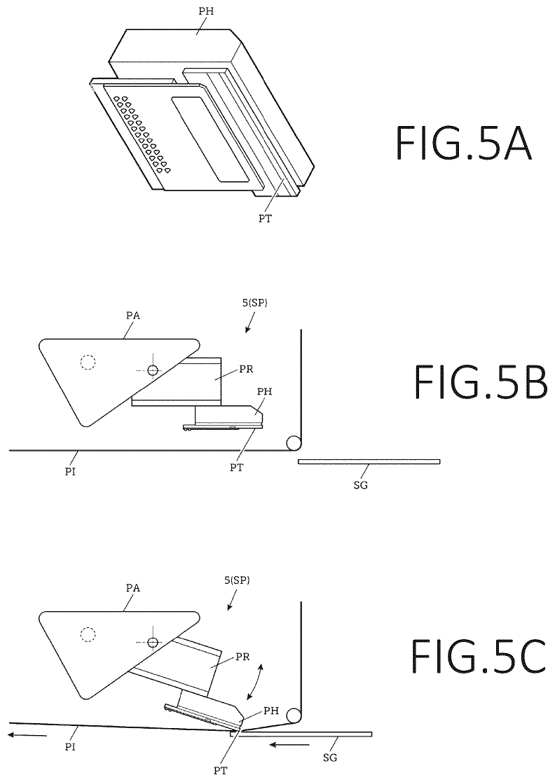

The printer 5 prints the machine-readable code m and the text information on the printing area SGf of the slide glass SG. FIG. 5A shows a thermal printer SP, which is an example of the printer 5, seen from below. FIG. 5B and FIG. 5C show the thermal printer SP seen from the side. The thermal printer SP includes a print head base PH, a heating unit PT provided at a rear end of the print head base PH, and an ink ribbon PI heated by the heating unit PT.

The heating unit PT has fine heating elements arranged in a row in the main scanning direction. The heating unit PT can selectively heat one or more heating elements. By bringing the ink ribbon PI into contact with the heating unit PT and heating the selected heating elements while the printing area SGf of the slide glass SG is pressed against the heating unit PT via the ink ribbon PI, the ink in the portion in contact with the heating element of the ink ribbon PI is melted. Thus, the melted ink adheres to the printing area SGf. By performing these operations while feeding the ink ribbon PI and the slide glass SG in the sub-scanning direction, machine-readable codes or characters are printed on the printing area SGf of the slide glass SG.

As shown in FIG. 5B, the support member PA is fixed to the printer 5. The rotating member PR is rotatably supported by the support member PA. The print head base PH is fixed to the rotating member PR. As shown in FIG. 5C, by rotating the print head base PH downward against the support member PA together with the rotating member PR, the heating unit PT can be pressed against the printing area SGf via the ink ribbon PI to perform printing. The heating unit PT may be pressed against and stopped at the printing area SGf by a stopper (unillustrated). The mechanism to rotate the rotating member PR is, for example, a mechanism including a gear and a cam. When printing is not performed, the print head base PH can be rotated upward together with the rotating member PR by the biased force of a spring mechanism (unillustrated), and the heating unit PT can be separated from the slide glass SG. The pressing direction is not limited. Not only the case of pressing the heating unit PT against the slide glass SG via the ink ribbon PL, but also the slide glass SG may be pressed against the heating unit PT via the ink ribbon PI. In a state in which the slide glass SG is held on a holding mechanism (unillustrated), the printing process can be performed by vertically moving the holding mechanism (unillustrated) using a vertical positioning member (unillustrated) or the like.

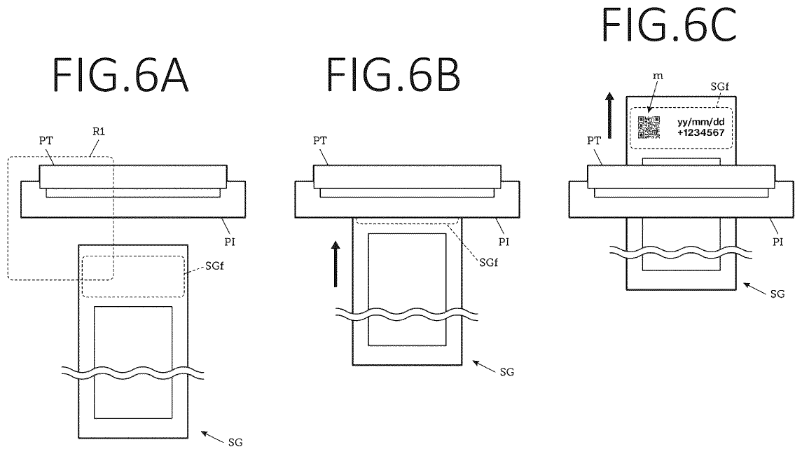

FIGS. 6A-6C are schematic diagrams showing a process of printing the machine-readable code m and the text information on the slide glass SG. FIG. 6A shows a state before printing. FIG. 6B shows a state during printing. FIG. 6C shows a state after printing. During printing, the print head base PH is repeatedly pressed against the slide glass SG at a high speed. In this example, a QR code is printed as the machine-readable code m on the printing area SGf of the slide glass SG, and a date and a specimen number are printed as the text information. The printing of the machine-readable code m on the printing area SGf of the slide glass SG is performed based on the blood collection tube identification information read by the blood collection tube reader 9 from the blood collection tube BP in which the collected blood is accommodated.

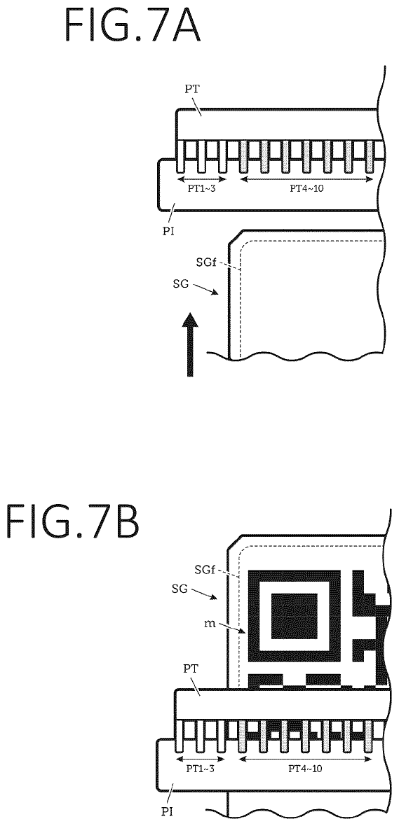

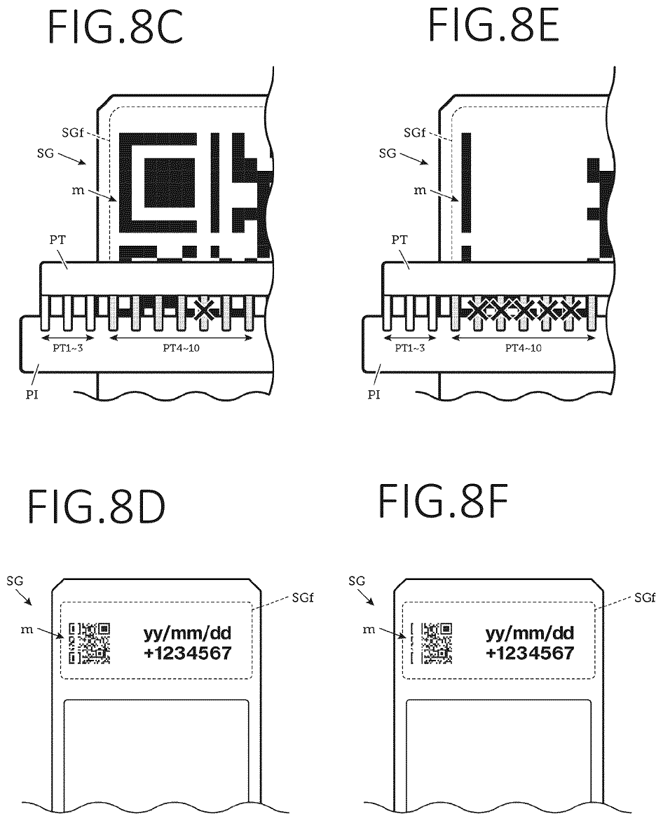

FIG. 7A is a partial enlarged view of an R1 portion of FIG. 6A. The heating elements PT1 to PT10 are fixed to the print head base PH. When printing is performed at the positions of the heating elements PT4 to PT10, the heating elements PT4 to PT10 are heated, and the dissolved ink as shown in FIG. 7B adheres to the printing area SGf. As described above, since the print head base PH is repeatedly pressed against the slide glass SG at a high speed, the heating elements PT4 to PT10 are repeatedly subjected to strong impacts at multiple times. Since the slide glass is made of a hard material, the impact on the heating element when pressed is particularly large, which can cause breakages of the heating element. Besides, fine glass powder may be adhered to the surface of the slide glass SG. When the heating elements hits the small bumps of the glass powder on the slide glass SG, a strong force is applied to the heating elements, which also causes breakages of the heating element. When the heating element is broken, the heating element is not heated, and the ink cannot be attached to the printing area SGf, and dots corresponding to the heating element cannot be formed. For example, when the heating element PT8 is broken, printing is missing in the sub-scanning direction as shown in FIG. 8C and FIG. 8D. When the heating elements PT5 to PT9 are broken, printing is missing in the sub-scanning direction as shown in FIG. 8E and FIG. 8F.

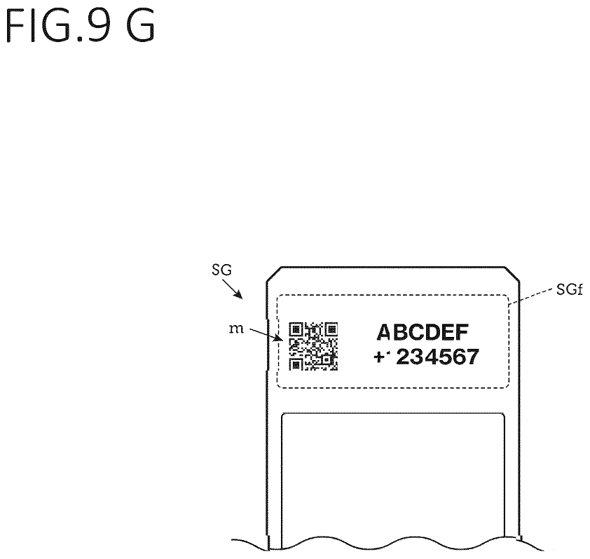

The breakages of the heating elements occur randomly. For example, the heating elements corresponding to the dots of the QR code may break, or the heating elements corresponding to the dots of the text information may break. For example, when the heating elements corresponding to the QR code break, the QR code will be partially missing as shown in FIG. 8E and FIG. 8F. When the heating elements corresponding to the text information break, the text information will be partially missing as shown in FIG. 9G. For example, even if a character “A” in the patient's name written in the alphabet is missing, the identification of the character would not be affected. However, if a number “1” included in the specimen number consisting of the number is missing, the specimen number itself changes, making visual identification of the slide glass impossible. As described above, the defect of printing due to the breakage of the heating elements occurs at random, thus the outcome of the printing defect on the identification of the slide glass SG cannot be expected. For that reason, the conventional smearing apparatus was configured to monitor about 400 heating elements arranged in the scanning direction, and suspend the printing only due to a few breakages (e.g., 1 to 2 breakages) of the heating elements. While this arrangement was beneficial in increasing a visual identifiability of the slide glass, it also causes the smearing apparatus to be frequently stopped, thereby shortening the MTBF (Mean Time Between Failure).

In the present embodiment, instead of controlling the smearing apparatus based on the presence or absence of breakages of heating elements generated at random, the smearing apparatus is controlled based on information indicating availability (hereinafter, referred to as “availability”, as appropriate) of the printer 5 to print a machine-readable code m with a sufficient print quality for a machine-based automatic scanning and/or reading (hereinafter, referred to as “availability information”). Thus, even if breakages of the heating elements occur, printing by the smearing apparatus is continued as long as the printer 5 has the availability to print the machine-readable code m that can be automatically scanned or read by machines. By adopting such a configuration, it is possible to avoid frequent interruption of the smearing apparatus and to improve the MTBF. The control according to the present embodiment will be described later.

### (Reader 7)

Referring to FIG. 3, the reader 7 will be described. The reader 7 is configured to read the machine-readable code m, such as a QR code, printed by the printer 5. The reader 7 includes a camera that performs imaging, an image processing unit that decodes the captured image, and the like. The reader 7 is arranged so as to image the printing area SGf of the slide glass SG. Upon reading the machine-readable code m based on the captured image, the reader 7 transmits the machine-readable code m to the controller 21. When the reader 7 fails to decode from the captured image, the reader 7 transmits information of the reading error to the controller 21. Cases of failure of decoding may include, for example, a case of timeout due to inability to detect the finder pattern, or failure of decoding to the specific format due to an excessive data area corruption which prohibits an error correction function. As described above, the controller 21 obtains, by the reader 7, the machine-readable code m or the information of the reading error as the reading result.

The reader 7 may not include an image processing unit that performs decoding. In this case, the controller 21 may decode the captured image obtained from the reader 7.

The reader 7 may detect a missing part of printing in addition to decoding the printed machine-readable code m. Instead of the reader 7 detecting the missing part of printing, the controller 21 that has acquired the captured image from the reader 7 may detect the missing part of printing.

The reader 7 may be the same as the blood collection tube reader 9.

The reader 7 may not be provided in the smearing apparatus 1. For example, a reader having a similar function may be provided in the slide transport apparatus 100 or the imaging apparatus 200, which can communicate with the smearing apparatus 1. These embodiments will be described later.

### (Blood Collection Tube Reader 9)

The blood collection tube reader 9 includes, for example, a camera that performs image acquisition, similarly to the reader 7. The blood collection tube reader 9 reads blood collection tube identification information such as a bar code displayed on the blood collection tube BP and transmits the blood collection tube identification information as a specimen number to the controller 21.

### (Smearing Unit 11)

The smearing unit 11 has a function of smearing a specimen on the slide glass SG. The smearing unit 11 aspirates the specimen by a specimen suction mechanism (unillustrated), drops the specimen onto the smearing area SGa of the slide glass SG, and performs smearing process by a smearing mechanism according to the smearing method. For example, the specimen is smeared on the smearing area SGa by a smearing method such as Wedge method, which uses a smear material (unillustrated) like a spreader slide (unillustrated).

### (Drying Unit 12)

The drying unit 12 has a function of receiving the slide glass SG on which the specimen is smeared from the smearing unit 11, and drying the specimen smeared on the slide glass SG by blowing air to the smearing portion SGa of the slide glass SG. The drying unit 12 may be included in the smearing unit 11.

### (Staining Unit 13)

The staining unit 13 includes a staining tank 120 and a drying tank 50 described below. The staining unit 13 stores staining solution and stains the slide glass SG smeared by the smearing unit 11 by immersing the slide glass SG in the staining solution. The staining tank 120 and the drying tank 50 may be configured to be able to hold a plurality of slide glasses SG.

The staining unit 13 performs the staining process and the washing process on the slide glass SG, which has undergone the smearing and the drying by drying unit 12, using the staining tanks 120a, 120b, 120c, 120d and 120e of the staining tank 120, and the washing tanks 40a and 40b. The slide glass SG after staining is dried by blowing in a drying tank 50. After staining and drying, the slide glass SG is transferred to the slide glass storage 86 by a transfer unit (unillustrated).

The staining tank 120 has a container shape that can accommodate the slide glass SG, and a staining solution is stored therein. The washing tank 40 has a container shape that can accommodate the slide glass SG, and the washing liquid is stored therein. Three staining tanks 120a, 120b and 120c, a washing tank 40a, two staining tanks 120d and 120e, and a washing tank 40b are arranged in this order along the Y-axis direction. The number of staining tanks 120 and the number of washing tanks 40 can be appropriately changed according to the contents of the staining process, the number of steps, and the like.

### (Input Unit 15, Display 17, and Data Storage 19)

The input unit 15 receives an input to the smearing apparatus 1. The input unit 15 may be configured by, for example, a hardware key such as a keyboard or a pointing device such as a mouse. The input unit 15 may be a touch panel, a camera (for operation input via a moving image), or a microphone (for operation input via voice). The display 17 displays a status of the smearing apparatus 1, data regarding the specimen, information for user input, and the like. The display 17 is, for example, a liquid crystal display, an OELD (organic electroluminescence display), or the like. The data storage 19 has a function of storing various programs and various data necessary for the smearing apparatus 1 to operate. As the data storage 19, a variety of storage media may be used such as an HDD (hard disk drive), an SSD (solid state drive), a flash memory, a RAM (random access memory), and a ROM (read only memory), for example.

### (Controller 21, Communication Unit 23)

The controller 21 includes a circuit physically structured to provide a function by executing code or instructions included in the program. The controller 21 may be a data processing apparatus built in hardware. The controller 21 is, for example, a central processing unit (CPU), and may be a microprocessor, a processor core, a multi-processor, an ASIC, or an FPGA. The controller 21 controls the smearing apparatus 1 based on a program or the like stored in the memory 19. The communication unit 23 is communicably connected to the communication unit 111 of the slide transport apparatus 100 and the communication unit 204 of the imaging apparatus 200 and can transmit and receive information in order to perform an operation in cooperation with each other.

In the present embodiment, the controller 21 generates raster data for printing the machine-readable code (such as a two-dimensional code) and the specimen number based on the specimen number received from the blood collection tube reader 9. Then, the controller 21 executes control to perform printing by transmitting the raster data to the printer 5. The printer 5 performs printing by controlling ON/OFF of each heating element constituting the heating unit PT based on the received command. The printer 5 can perform the breakage check of the heating element at one or more predetermined timing, such as when the power is turned on (before the first printing is performed after the power-on), before printing on the slide glass SG, and after printing on the slide glass SG. The breakage check of the heating element will be described later.

The controller 21 may transmit to the printer 5, for example, print information including information to be encoded in at least the two-dimensional code (e.g., specimen number, date, and name). The printer 5 may generate raster data including at least a two-dimensional code based on the received print information and perform printing.

### (Slide Glass Storage 86)

The slide glass storage 86 stores the slide glass SG on which the staining process is completed in the magazine 90, and transports the slide glass SG by the magazine transport unit 91. The magazine transport unit 91 includes a magazine loading path 92 to store a plurality of magazines 90 in an empty state, a magazine unloading path 93 to store the magazine 90 containing the slide glasses SG that have completed the staining process, and a lateral transfer mechanism 94 to transfer magazines from the magazine loading path 92 to the magazine unloading path 93. The magazine 90 may store, for example, ten slide glasses SG separated by partitions. In the magazine transport unit 91, when the user sets the empty magazine 90 in the loading unit D of the magazine loading path 92, the magazine 90 is automatically transported in the direction of the slide storage position 95.

The slide glass SG that has undergone the staining process is picked up by a transfer unit (unillustrated) and stored in an empty storage section of the magazine 90 disposed at the slide storage position 95. The magazine 90 whose storage portion is full is laterally transferred from the magazine loading path 92 to the magazine unloading path 93 by the lateral transfer mechanism 94. The magazine 90 laterally transferred to the magazine unloading path 93 is automatically transported in the Y-axis forward direction. The magazine 90 transported to the foremost position is transferred by the lateral transfer unit 130 to the first supply area 131 of the slide transport apparatus 100.

### EMBODIMENTS

Hereinafter, some examples will be described focusing on the processes performed by the apparatus.

### First Embodiment

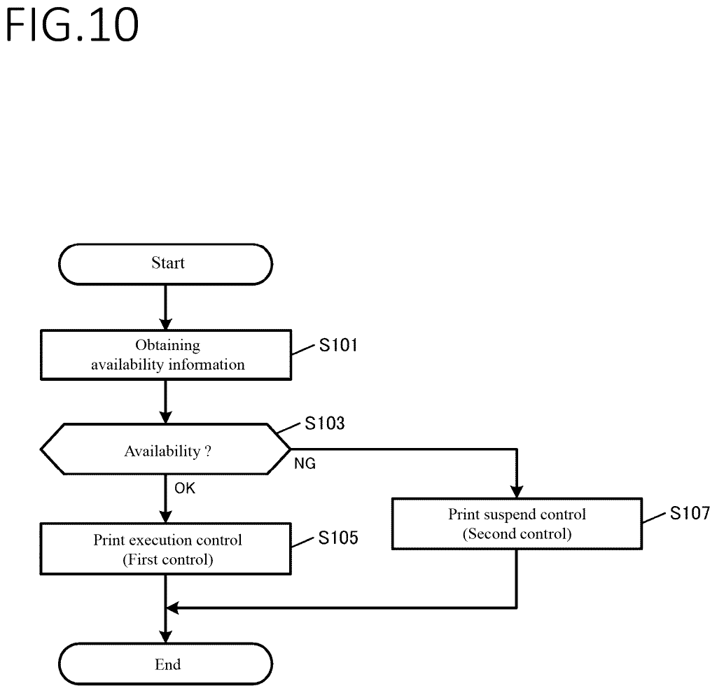

FIG. 10 is a flowchart showing an example of determination process performed by the controller 21 in the first embodiment. The process in the flowchart described below may be realized, for example, by the controller 21 reading out and executing a program stored in the memory 19. Hereinafter, each symbol S in the flowchart means a step.

This process is a control process based on availability information, performed before starting to print or after printing by the printer 5 to start printing. The availability information is information indicating whether the printer 5 can print the machine-readable code m that can be mechanically read by a reader (e.g., camera). The type of the availability information will be described later.

First, the controller 21 obtains the availability information (S101).

Next, the controller 21 determines the availability of the printer 5 that prints the machine-readable code m based on the availability information obtained in S101 (S103). When the controller 21 determines that the printer 5 is available (S103: OK), the controller 21 controls the printer 5 to execute printing (hereinafter, referred to as “print execution control”) (S105). The print execution control may be an example of the first control.

As the first control, in addition to the print execution control, control to issue an alert via an output unit such as the display 17 (hereinafter, referred to as “alert output control”), control to change the print mode of the printer 5 (hereinafter, referred to as “print mode change control”), and the like may be further performed. These details will be described later.

In the print execution control, the slide glass SG to be printed is supplied from the supply unit 3 to the printer 5, and printing is performed. The controller 21 transmits the raster data to the printer 5. Then, the printer 5 executes thermal printing based on the raster data on the slide glass SG.

On the other hand, when the controller 21 determines that the printer 5 is not available (S103: NG), the controller 21 performs, for example, control not to start printing (i.e., suspending printing) (hereinafter, referred to as “print suspend control”) (S107). The print suspend control may be an example of the second control.

In a case of performing the print suspend control as the second control, it may be notified that printing has been suspended (hereinafter, referred to as a “print suspend notification”) via an output unit such as the display 17.

After S105 or S107, the controller 21 ends the process.

### (Availability Information)

Next, the availability information will be described. The availability information is (i) information indicating whether reading of the machine-readable code m printed by the printer 5 was successful by the reader, or (ii) information indicating a condition of the printer 5 related to the readability of the machine-readable code m. In the case of (i), the printer 5 may actually print the machine-readable code m on the slide glass SG, and the controller 21 may obtain information on the reading result obtained by the reader 7 reading the machine-readable code m (hereinafter, appropriately referred to as “information on the reading result”) as the availability information. In the case of (ii), as the information on the state of the printer 5, for example, information on breakages of heating elements output from the printer 5 (hereinafter, appropriately referred to as “information on breakages of heating elements”) may be acquired.

### (i) Information on the Reading Result

An example of obtaining information on the reading result as the availability information will be described.

In an example of acquiring the information on the reading result as the availability information, the controller 21 controls the printer 5 to print the machine-readable code m on the slide glass SG, controls the reader 7 to read the printed machine-readable code m, and obtains the reading result in S101. More specifically, the controller 21 causes the supply unit 3 to supply the slide glass SG to the printer 5, and controls the printer 5 to print the machine-readable code m. The slide glass SG on which the machine-readable code m is printed may be referred to as a first slide glass. Next, the controller 21 causes the printed first slide glass to be supplied from the printer 5 to the reader 7, and controls the reader 7 to read the machine-readable code m. When the reader 7 can decode the machine-readable code m, the controller 21 receives the decoded specimen information from the reader 7. When the reader 7 fails to decode, information indicating a reading error is transmitted to the controller 21.

When receiving the specimen information decoded in S103, in other words when the printer 5 is available, the controller 21 determines that the machine-readable code m is readable (S103: OK). In S105, the controller 21 performs processing continuation control on the first slide glass. As the processing continuation control, the controller 21 executes smearing of the specimen by the smearing unit 11, drying by the drying unit 12, and staining by the staining unit 13 on the first slide glass. Further, the controller 21 performs the print execution control on the second slide glass that has reached the printer 5 following the first slide glass. The processing continuation control for the first slide glass and the print execution control for the second slide glass may be examples of the first control. After the first control, the controller 21 may perform smearing of the specimen on the first slide glass by the smearing unit 11, drying by the drying unit 12, and staining by the staining unit 13.

When receiving the information of the reading error in S103, in other words when the availability is not confirmed, the controller 21 determines that the machine-readable code m is not readable (S103: NG), and suspends the processing in S107. When the processing is suspended, the controller 21 suspends the processing on the first slide glass. Further, the controller 21 controls to suspend printing on the second slide glass, which has reached the printer 5 following the first slide glass. For example, the controller 21 may discharge the first slide glass without performing smearing of the specimen by the smearing unit 11, drying by the drying unit 12, and staining by the staining unit 13. When the other slide glass SG is being processed in the smearing unit 11, the drying unit 12, or the staining unit 13, the processing for the other slide glass SG may be continued while suspending the processing for the first slide glass and the second slide glass.

In the case where a plurality of machine-readable codes are printed on the slide glass, the reader 7 may attempt to read all machine-readable codes. When at least one of the multiple machine-readable codes is readable, the first control may be executed. If all the machine-readable codes are determined to be unreadable, the second control may be executed.

### (ii) Information on Breakages of Heating Elements

Hereinafter, an example of obtaining information on breakages of heating elements as the availability information will be described. In an example of acquiring information on breakages of heating elements as the availability information, the controller 21 controls the printer 5 to execute a breakage check in S101. In the breakage check, for example, the printer 5 compares the resistance value of each heating element with a threshold value. The printer 5 determines that the heating element is broken when the resistance value is equal to or greater than a predetermined value. The printer 5 transmits an assigned number corresponding to the broken heating element to the controller 21. The controller 21 may identify a number of the broken heating elements and positions thereof according to the assigned numbers of broken heating elements.

It may be further determined that the heating element is likely to break in the near future if the resistance value is observed to be lower, by a predetermined difference, than the threshold value of detecting a breakage. In this case, the printer 5 may transmit the number of the heating element that can be broken in the near future to the controller 21, and the controller 21 may specify information on the number and the position of the heating element that can be broken in the near future. The specified numbers of heating elements that can be broken soon may be included in “the number of broken heating elements”, or may not be included. The specified position of the heating element that can be broken soon may be included in “the position of the broken heating element” or may not be included.

The availability is determined based on a result of the breakage check on the heating elements corresponding to the printing position of the machine-readable code. The controller 21 determines that the machine-readable code m is not readable when breakages are detected at a predetermined number or more of the heating elements corresponding to the printing position of the machine-readable code and/or at predetermined positions of the heating elements corresponding to the printing position of the machine-readable code. For example, when the number of breakages reaches “A consecutive heating elements or B random heating elements” (A and B are numerals) among the heating elements corresponding to the dots of the machine-readable code m, it is determined that the printer 5 is not available. In this case, the controller 21 determines that availability is OK (S103: OK) if neither the number of consecutive broken heating elements corresponding to the dots of the machine-readable code m reaches A, nor the total number of broken heating elements (hereinafter referred to as “random broken heating elements”) reaches B, regardless of whether they are consecutive or not. Then, the controller 21 performs print execution control (S105). The print execution control may be an example of the first control. In the print execution control, the slide glass SG to be printed is supplied from the supply unit 3 to the printer 5, and printing is performed. The controller 21 transmits the raster data to the printer 5. Then, the printer 5 executes thermal printing on the slide glass SG based on the raster data.

On the other hand, for example, if at least one of the following conditions is met: the number of consecutive broken heating elements corresponding to the dots of the machine-readable code m reaches A, or the number of random broken heating elements reaches B, the controller 21 determines that the availability is NG (S103: NG). Then, for example, the controller 21 performs print suspend control (S107). The print suspend control may be an example of the second control.

Further, a condition for breakages of the heating elements may be set, and the controller 21 may determine whether to include the alert output control as the first control based on the condition. For example, the alert output control may be executed in addition to the print execution control with a smaller number of broken heating elements than in the case where the print suspend control is executed as the second control. If none of the conditions are met, it may be determined that only the print execution control is executed. This point will be described later.

A user may set a condition regarding monitoring of the heating element, including a monitoring range of the heating element, and perform the breakage check considering the condition. This point will be described later.

### (Modification of the First Control)

The controller 21 may further perform, as the first control, additional controls such as an alert output control and a print mode change control in addition to the print execution control described above. These details will be described.

The alert output control is, for example, control to control the display 17 to display a message indicating that an abnormality of the printer 5 is detected. As the alert output control, an alert message or an alert sound may be output to a sound output unit (unillustrated).

The alert output control is executed according to the state of the printer 5. The information for determining the state of the printer 5 may be information on the reading result, or information on the number and position of breakages of the heating elements of the printer 5. For example, even if it is determined that the printer 5 is available, the alert output control may be executed when breakages are detected at a predetermined number of the heating elements corresponding to the printing position of the machine-readable code m and/or at a predetermined positions of the heating elements corresponding to the printing position of the machine-readable code m. Even if it is determined that the printer 5 is available, when breakages are detected in the heating elements corresponding to the position of printing of the text information, the alert output control may be executed. The user may set a condition for executing the alert output control. This will be described later.

The print mode change control is a control of changing the print mode from the first mode to the second mode before the print execution control. The print mode change control may be executed when the printer 5 is determined to be available but yet there is a breakage in the printer 5 or a missing printing is detected.

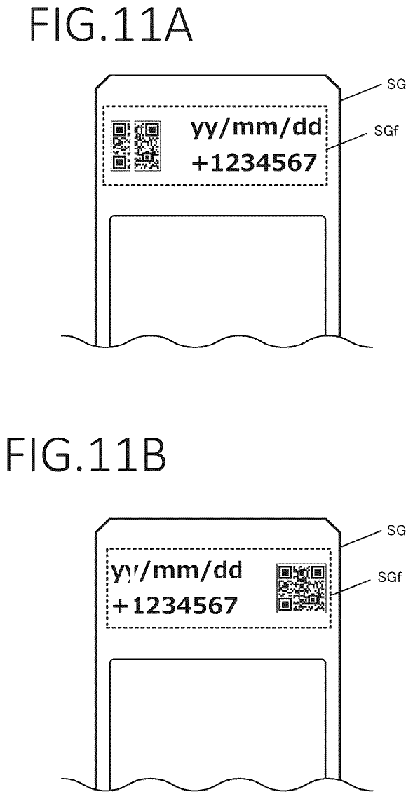

FIGS. 11A and 11B show an example of a print mode, and FIG. 11A shows an example of a first mode and FIG. 11B shows an example of a second mode. In this example, the first mode is a mode in which the QR code as the machine-readable code m is printed on the left side and the specimen number as the text information is printed on the right side of the printing area SGf. In contrast, in the second mode, the QR code as the machine-readable code m is printed on the right side of the printing area SGf, and the specimen number as the text information is printed on the left side. That is, the second mode is a mode in which the position of the machine-readable code m differs from the first mode.

The machine-readable code m may be a machine-readable code, such as a QR code, as described above, and the second mode may be a mode in which the position of the machine-readable code is different from the first mode.

FIG. 11A shows states in which a part of the QR code is missing due to breakages of the heating elements. In this case, there is a possibility that the QR code is unreadable. Changing to the second mode as shown in FIG. 11B should improve the readability of the QR code because it allows the QR code to be printed on the right side without missing although the character on the left side is partially missing. In this way, the readability of the machine-readable code m can be increased.

For example, when it is expected that the finder pattern or the alignment pattern in the QR code will be missing (e.g., left or right corners of the QR code), the reader 7 may not be able to detect the finder pattern or the alignment pattern, which may result in failure of reading the QR code. Therefore, for example, the second mode may be a print mode in which the QR code printing position is shifted laterally, for example by the predetermined number of printing dots, from the first mode. Alternatively, in a case where the position of the broken heating elements is recognized, the second mode may be a mode in which printing is performed while avoiding the position of the broken heating elements. In the second mode, the data area may be missing while the finder pattern and the alignment pattern are printed. However, since the data in the data area can be corrected by the error correction code according to the error correction level, the QR code can be decoded.

Similarly, when it is expected that the format information in the QR code will be missing, the printing position of the QR code may be shifted laterally to change to the second mode for allowing decoding.

In the second mode, the angle of the machine-readable code m may be changed from the first mode. For example, the first mode may be a mode in which the QR code is printed in a normal mode (default mode), and the second mode may be a mode in which the QR code is printed with a rotation by a predetermined angle from the normal mode. The predetermined angle may be, for example, an angle of 45 degrees, 90 degrees, or the like.

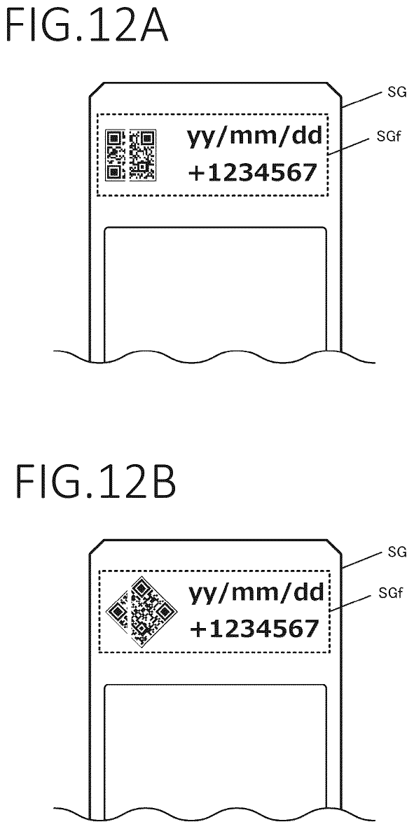

FIGS. 12A and 12B show examples of print modes according to the above-mentioned configuration. FIG. 12A shows an example of the first mode and FIG. 12B shows an example of the second mode. In this example, in the second mode, the QR code is printed in an arrangement in which the QR code is rotated 45 degrees clockwise in the printing area SGf.

FIG. 12A illustrates an example in which a part of the QR code is missing due to breakages of the heating elements. In this case, there is a possibility that the QR code cannot be read because the predetermined region of the data area is missing. However, in the second mode as shown in FIG. 12B, the missing region in the data area becomes smaller by the rotation of the QR code, thereby increasing the readability of the QR code. In this way, the readability of the machine-readable code m can be increased.

The controller 21 may determine, based on the availability information, the rotation angle so that the breakage does not overlap the alignment pattern or the finder pattern.

The first and the second mode may have varied sizes of machine-readable codes. For example, in the second mode, the symbol of the QR code may be downsized (the number of cells may be reduced) than the first mode as long as the amount of information stored in the code is sufficient. Alternatively, the version of QR Code may be decreased. In this way, the code printed in the second mode may be prevented from overlapping with the broken heating element.

The second mode may be a code produced by combining two or more of the above-described methods such as lateral movement, rotation, and downsizing of the machine-readable code of the first mode.

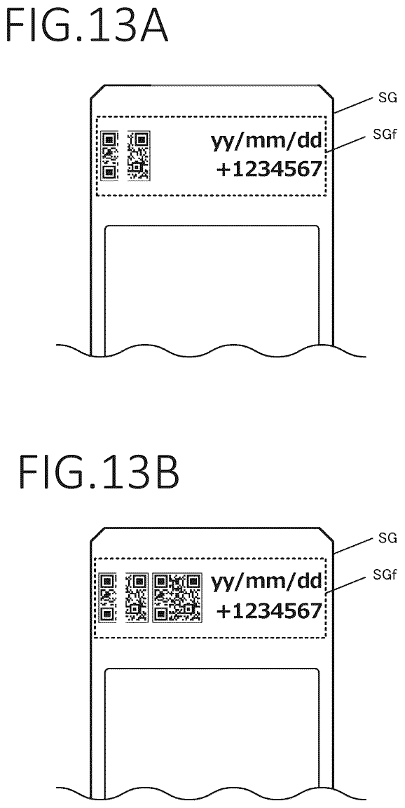

FIGS. 13A and 13B show another example of the print mode. FIG. 13A shows another example of the first mode. FIG. 13B shows another example of the second mode. In this example, two identical QR codes are printed side by side on the left side of the printing area SGf. The specimen number is printed on the right part. In other words, the second mode is a mode in which the number of the printed QR codes, which are examples of machine-readable codes including error correction codes, differs from the first mode.

FIG. 13A illustrates an example in which a part of the QR code on the left side is missing due to breakages of the heating elements. In this case, the QR code on the left side may be unreadable. By changing to the second mode as shown in FIG. 13B, although the QR code on the left side remains incomplete, the QR code on the right side is not missing, which ensures a readability of at least one QR code. In this way, the readability of the machine-readable code m can be increased.

In the second mode, printed information other than the machine-readable code may be reduced in order to make a space and multiple copies of the machine-readable codes with error correction symbol may be printed in the space. The printed information other than the machine-readable code includes, for example, text information such as a specimen number, a date, and a patient name.

A plurality of types of slide glass SG having varied sizes of the printing area SGf may be prepared in advance. In the case of printing in the second mode to avoid the broken heating elements, the QR code may not be accommodated in the printing area SGf of the slide glass SG. In this case, another slide glass SG with if a larger printing area SGf may be accommodated. Therefore, the controller 21 may control the display 17 to display, as the alert output control, information urging the user to use, for example, a slide glass SG having a larger printing area SGf.

In a case where the print mode change control is performed, the controller 21 may perform a print mode change notification. For example, the controller 21 may control the display 17 to display information indicating that the print mode has been changed or information capable of recognizing the changed print mode. The controller 21 may control the sound output unit to perform sound output.

The controller 21 may perform both the print mode change control and the alert output control in addition to the print execution control, for example.

The print mode change control may be performed, for example, every time before printing on the slide glass, or may be performed after printing on a predetermined number of slide glasses and before the print execution control of the next slide. In this case, it is possible to distribute the heating elements used for printing the machine-readable code, reducing the occurrence of breakages of the heating elements.

The necessity of the alert output control and the print mode change control may be determined according to the availability information.

For example, the alert output control or the print mode change control may be executed when it is determined that the printer has an availability on the basis of the information on the reading result obtained as the availability information, and thereafter a missing in the printing within a predetermined range is detected by the reader 7.

For example, in a case where information on breakages of heating elements is obtained as the availability information, and the broken heating elements are in a predetermined number and positions, the alert output control or the print mode change control may be executed.

The determination of availability by the controller 21 and the determination of whether to execute the alert output control and the print mode change control may use different types of availability information. For example, when information on the reading result is obtained and the controller 21 determines that reading is possible, it may be determined that the printer has an availability and the print execution control may be performed. Thereafter, information on breakages of heating elements may be obtained further, and it may be determined whether the execution of the alert output control or the print mode change control is necessary.

### (Specific Examples of Alert Output Condition and Print Suspend Condition)

It has been described above that there may be a case where the alert output control is executed and a case where the print suspend control is executed. The controller 21 may determine whether a condition for suspending printing (hereinafter, referred to as a “print suspend condition”) is satisfied based on the obtained information on breakages of heating elements. In other words, the print suspend condition can be expressed as a condition by which the controller 21 determines which of the first control and the second control is to be performed. Further, the controller 21 may determine on the condition for alert output control (hereinafter, referred to as a “alert output condition”). In other words, the alert output condition can be expressed as a condition by which the controller 21 determines whether to perform only the print execution control as the first control or to perform the alert output control in addition to the print execution control, after the controller 21 determines to perform the first control. The conditions such as the print suspend condition and the alert output condition in the above processing may be stored in advance in the data storage 19, and the controller 21 may perform the determination based on the condition stored in the data storage 19. Hereinafter, execution conditions of the alert output control and the print suspend control will be described.

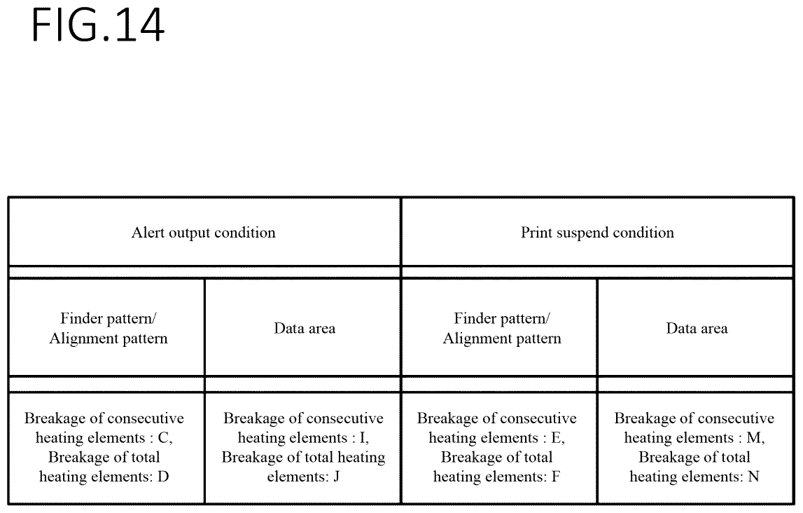

FIG. 14 shows an example of condition setting data which is an example of data stored in the data storage 19 in this case. The condition set based on the information on the number of breakages of the heating elements is exemplified. In the expression “Breakage of consecutive heating elements: X, Total breakages of heating elements: Y”, “X” and “Y” refer to the number of heating elements. In addition, since the positions of the breakages also matter, information on the positions of breakages of the heating elements is also required.

In the condition setting data, a monitoring range, an alert output condition, and a print suspend condition are set in association with each other.

For each of the alert output condition and a print suspend condition, (A) finder pattern/alignment pattern and (B) data area of the QR code are defined.

(A) Finder pattern/Alignment Pattern

The finder patterns are patterns arranged at three corners of the QR code. The alignment pattern is a pattern arranged in the QR code for correcting positional deviations of cells caused by distortion.

An alert output condition is defined as “Breakage of consecutive heating elements: C, Breakage of total heating elements: D” In this case, the controller 21 may perform alert output control when it determines that at least one of the following conditions is satisfied among the heating elements used for printing the finder patterns or the alignment patterns: (i) the number of breakages of consecutive heating elements reaches C, or (ii) the total number of breakages of heating elements reaches D.

“Breakages of consecutive heating elements: E, Total breakages of heating elements: F” are defined as the print suspend condition. This means that the controller 21 may perform the print suspend control if it determines that at least one of the following conditions is met for the heating elements used for printing the finder pattern or alignment pattern: (i) the number of consecutive broken heating elements reaches E, or (ii) the total number of broken heating elements reaches F. In this case, the number of broken elements for the alert output condition may be set to be fewer than that for the print suspend condition. For example, the number of breakages may be set such that “C<E” and “D<F”.

### (B) Data Area

“Breakages of consecutive heating elements: I, Total breakages of total heating elements: J” are defined in the alert output condition. This means that the controller 21 may perform the alert output control if it determines that at least one of the following conditions is met for the heating elements used for printing the finder pattern or alignment pattern: (i) the number of consecutive broken heating elements reaches I, or (ii) the number of total broken heating elements reaches J.

“Breakages of consecutive heating elements: M, Total breakages of total heating elements: N” are defined as the print suspend condition. This means that the controller 21 may perform the print suspend control if it determines that at least one of the following conditions is met for the heating elements used for printing the finder pattern or alignment pattern: (i) the number of consecutive broken heating elements reaches M, or (ii) the total number of broken heating elements reaches N. In this case, the number of broken elements for the alert output conditions may be set to be fewer than the number of print suspend conditions. For example, the number of breakages may be set such that “I<M” and “J<N”

For example, since the finder pattern or the alignment pattern significantly affect the reading accuracy, the number of broken elements for these patterns may be set to be fewer than that for the data area conditions. For example, the number of breakages may be set such that “C<I” and “E<M” for “Breakages of consecutive heating elements”. The number of breakages may be set such that “D<J” and “F<N” for “Total breakages of heating elements”.

The data area of the QR code includes a vertical area where format information, such as mask patterns necessary for decoding, is stored. In this area, conditions similar to the finder pattern and alignment pattern may be applied.

As described above, the number of QR codes may be one or more. The monitoring range “the QR code range only” may include both cases where the number of QR codes is one and where it is multiple. For example, in a case where the number of QR codes is two, the alert output control is performed in a case where it is determined that the alert output condition is satisfied for at least one QR code. The print suspend control is performed in a case where it is determined that both QR codes satisfies the print suspend condition.

### (the User Sets the Alert Output Condition)

The user may set the alert output conditions. Hereinafter, the alert output conditions set by the user are referred to as “user-set conditions”.

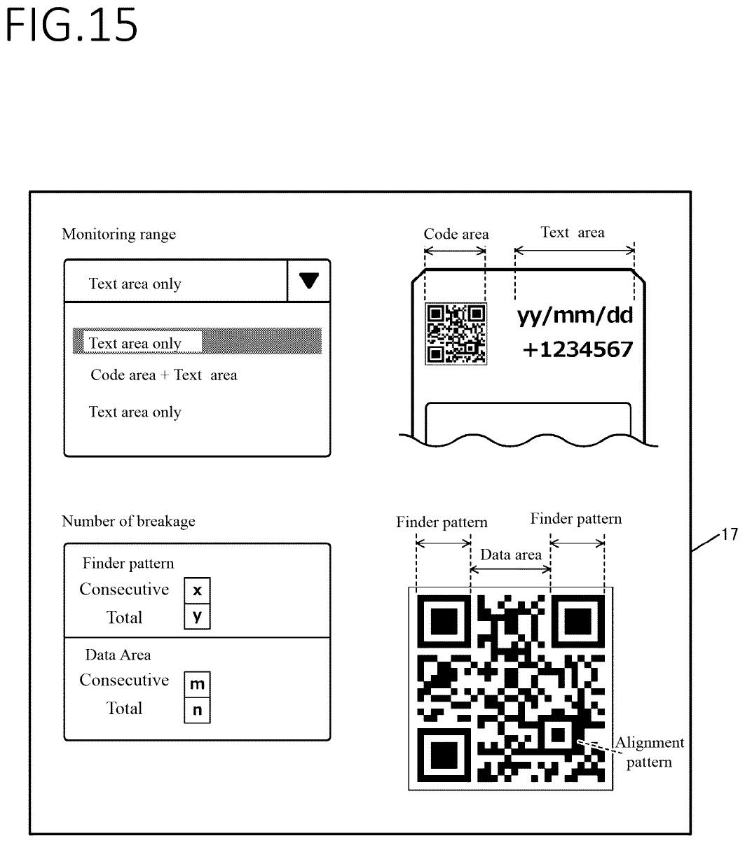

FIG. 15 shows an example of a condition setting screen displayed on the display 17 in this embodiment. In the condition setting screen, a box for setting a monitoring range for outputting an alert is provided at an upper left part, and in this example, any one of “Code area only”, “Code area+Text area” and “Text area only” can be selected by the user in the pull-down menu.

Under the box, an area including an input box for setting the number of breakages as the user-set conditions is displayed. In this example, there are boxes for inputting the number of consecutive breakages and the number of total breakages are set as the conditions for the finder pattern of the QR code. The screen also includes boxes for inputting, as the conditions for the data area of the QR code, the number of consecutive breakages and the number of total breakages. The conditions for the alignment pattern of the QR codes may be similarly configured.

In the upper right part of the screen, there is a sample image allowing the user to recognize the printing mode of the machine-readable code m. In the sample image, the code area where the machine-readable code m is printed and the text area where text is printed on the slide glass SG are highlighted. In the lower right part of the screen, an image of a sample of the machine-readable code m to be printed, in this example, an image of a sample of the QR code, is displayed.

The user can set the monitoring range and the number of breakages displayed on the left side of the screen by operating the input unit 15 while viewing the images of the sample displayed on the right side of the screen.

The user-set conditions are based on the monitoring range set by the user and the number and positions of broken heating elements. The user-set conditions may be determined to be met if it is determined that there are a set number of broken elements at the set breakage positions among the heating elements included in the set monitoring range.

### Effect of First Embodiment

According to this embodiment, the availability information of the machine-readable code is obtained. The control for executing the printing of the machine-readable code by the printer or control for suspending the printing of the printer is executed based on the availability information. Even when an abnormality occurs in the printer, it is possible to continue the processing of smear specimens as long as reading is possible. Therefore, both the identification of the slide glass and the continuation of the smear specimen preparing can be achieved.

By executing the alert output control as the control based on the state of the printer, the user can recognize that an abnormality is detected and take a measure for eliminating the abnormality.

By executing the print mode change control as the control based on the availability information, it is possible to enhance the readability of the machine-readable code. Further, even when an abnormality occurs in the printer, it is possible to enhance the readability of the machine-readable code by changing the printing position. Further, even when an abnormality occurs in the printer, it is possible to enhance the readability of the machine-readable code by changing the printing angle. Further, even when an abnormality occurs in the printer, it is possible to enhance the readability of the machine-readable code by changing the number of printings.

By obtaining the result of reading the machine-readable code printed on the slide glass as the availability information of the machine-readable code, control based on the reading result is performed. This allows the processing of smear specimens to continue as long as reading is possible, even if an abnormality occurs in the printer. Therefore, it contributes to both the continuation of smear specimen production and the identification of the slide glass. If the slide glass for which the reading results have been obtained is readable, the processing on the slide is continued. This contributes to both continuation of smear preparation and identification of the slide glass. The image processing technique is applied to the captured image by the camera, so that the machine-readable code can be easily read. The influence of the abnormality of the printer in the smearing apparatus can be reduced.

Since the smearing apparatus itself includes the reader, it is possible to reduce an influence caused by an abnormality of the printer included in the smearing apparatus alone. The reader reads multiple machine-readable codes printed on the slide glass. If at least one of the multiple machine-readable codes is readable, the first control is executed, and if all are unreadable, the second control is executed. This allows the smear processing to continue as long as there is at least one readable machine-readable code, even if an abnormality occurs in the printer. Therefore, it contributes to both continuation of smear preparation and identification of the slide glass.

By obtaining, as the availability information of the machine-readable code, information on breakages of heating elements before printing the machine-readable code on the slide glass, control based on the information is performed. This prevents the slide glass from being printed, which cannot be identified due to missing of the machine-readable code.

By executing the control based on the print suspend condition stored in advance, even when the heating elements corresponding to the printing position of the machine-readable code includes the broken heating elements, if the number is less than the predetermined number, the processing of the smear specimen can be continued. Therefore, it contributes to both the continuation of the smear preparation and the identification of the slide glass. The processing of smear specimens can continue if the position of the broken heating elements corresponding to the printing position of the machine-readable code is not at a predetermined position, even if broken heating elements are included. Therefore, it contributes to both the continuation of smear specimen production and the identification of the slide glass.

By allowing the user to set user-set conditions, the processing of smear specimens can continue if the user-set conditions are not met, even if broken heating elements are present. Therefore, it contributes to both the continuation of smear specimen production and the identification of the slide glass. By displaying the setting of the user-set conditions on the display unit, the user can examine the acceptable range of breakages based on the displayed information and set an arbitrary condition.

### Modification 1 of the First Embodiment

In the first embodiment described above, examples of obtaining, as availability information, either information on the reading result or information on the breakage of heating elements have been described. Hereinafter, a modification in which both information on the reading result and information on breakages of the heating element are acquired as the availability information will be described.

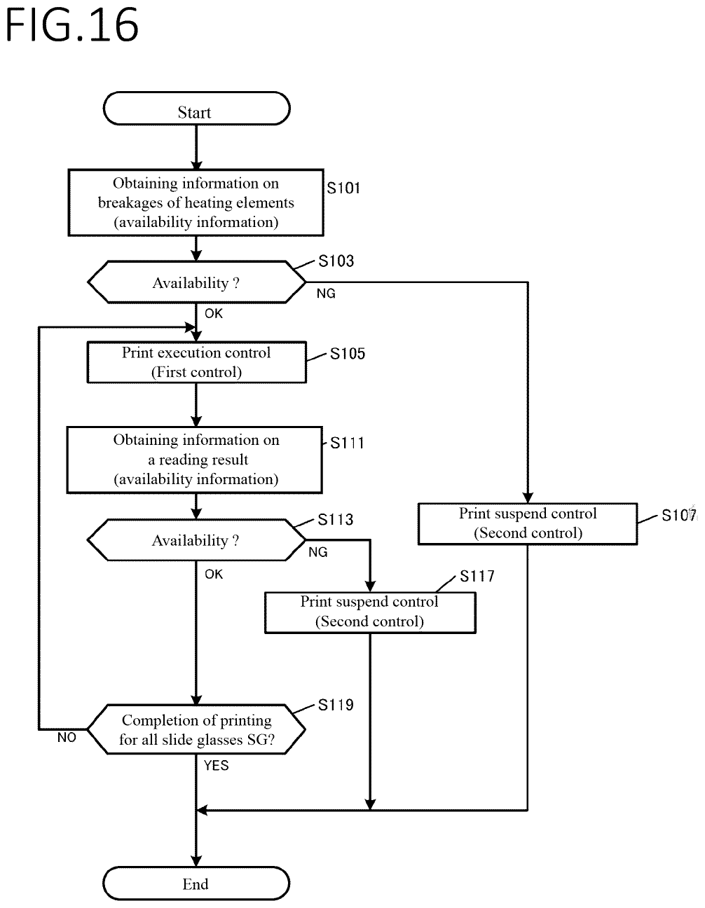

FIG. 16 is a flowchart showing another example of a flow of determination processing performed by the controller 21 in this embodiment. In this process, the controller 21 obtains availability information before executing the printing of the machine-readable code m on the slide glass SG by the printer 5, and further obtains availability information after executing the printing of the machine-readable code m on the slide glass SG by the printer 5.

First, the controller 21 obtains information on breakages of heating elements as availability information (S101).

If it is determined in S103 that the availability is OK (S103: OK), the controller 21 performs print execution control (an example of the first control) (S105), and controls the printer 5 to print the machine-readable code m on the slide glass SG. If it is determined in S103 that the availability is NG (S103: NO), the controller 21 executes the same processing as in step S107 described with reference to FIG. 10. For example, the controller 21 executes the print suspend control as the second control, and ends the process.

When printing in S105 is completed, the controller 21 obtains information on the reading result as the availability information (S111). The controller 21 further determines the availability of the printer 5 based on the information on the reading result acquired in S111 (S113). The availability information acquired in S111 is not limited to the information on the reading result, and may be information on breakages of heating elements, or may be both information on the reading result and information on breakages of heating elements. In S113, the determination may be performed based on at least one of the availability information.

If it is determined that the availability is OK (OK in S113), for example, the controller 21 sends out the slide glass SG of the printer 5, and supplies the slide glass SG as a new printing target from the supply unit 3 to the printer 5, thereby continuing the printing (S119: NO→S105). A series of controls for continuing the printing (hereinafter, referred to as “print continuation control”) may be an example of the first control.

When the print continuation control is performed, the smear specimen preparation process is continued. Therefore, it may be said that performing the print continuation control is, for example, performing control to continue the processing of smear specimens such as smearing, drying, and staining in the smearing apparatus 1.

The controller 21 determines, for example, whether printing of all slide glasses SG that need to be printed has been completed (S119). When it is determined that the printing is completed (S119: YES), the controller 21 ends the processing. When it is determined that printing is not completed (S119: NO), the controller 21 returns the process to S105, for example.

If it is determined in step S113 that the availability is NG (S113: NG), the controller 21 executes the same processing as S107 described in FIG. 10. In other words, the print suspend control is executed as the second control, and the process ends (S117).

If it is determined in S113 that the availability is OK (S113: OK), the controller 21 may further perform a first control, such as the alert output control or the print mode change control based on the availability information (e.g., information on the reading result) acquired in S111. In other words, after the print execution control (first control) is executed in S105 based on the availability information acquired in S101, the first control such as the alert output control and the print mode change control may be further executed based on the availability information acquired in S111. The controller 21 may execute the process in S119 after executing the first control. In other words, after the first control such as the alert output control and the print mode change control are executed based on the availability information acquired in S111, the next slide glass SG may be further subjected to the print execution control (first control) in S105 (S105 after S119: NO).

The controller 21 may further issue a print suspend notification when performing the print suspend control in S107 and S117.

The conditions for determining the type of the first control and the conditions for performing the second control, such as the condition for performing the alert output control and the condition for performing the print suspend control, may be set by user or the like.

For example, the process of controlling based on the reading results of the code may be combined with the process of controlling based on the results of condition determinations, such as alert output conditions and print stop conditions.

### Second Embodiment

The Second Embodiment relates to an embodiment in which the controller 21 controls to print multiple copies of the machine-readable code for identifying the specimen on the slide glass.

The processes in this embodiment can be applied to the various embodiments and their modifications described above. For example, the processes of FIG. 10 or FIG. 16 may be applied to this embodiment. In this case, the default printing mode may be set to print multiple copies of the same machine-readable code. The controller 21 may control the printer 5 to print in the set printing mode.

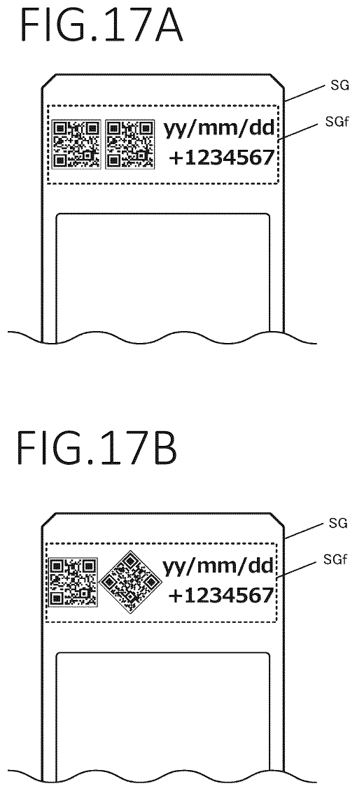

For example, as shown in FIG. 17A, the default printing mode may be set to print two identical QR codes, which are machine-readable codes, in the main scanning direction. In other words, on a single slide glass SG, first machine-readable code may be printed at a different position from second machine-readable code.

In this case, even if the heating elements used for printing one QR code are broken and the QR code cannot be read, it may be possible to read the other QR code. In other words, when printing the first machine-readable code and the second machine-readable code on the slide glass SG, one of the machine-readable codes may be still readable even if the other is unreadable.

The same machine-readable code may be printed three or more times. It may be a barcode instead of a QR code. A combination of barcodes and QR codes may be used, for example, in any of the following patterns:
One barcode and multiple QR codes
Multiple barcodes and one QR code
Multiple barcodes and multiple QR codes (The number of barcodes and QR codes may be the same or different.)

For example, as shown in FIG. 17B, the controller 21 may control the printer 5 to print one QR code (an example of the first machine-readable code) in a normal mode and another QR code (an example of the second machine-readable code) in a mode rotated by a predetermined angle from the normal mode. In other words, on a slide glass SG, first machine-readable code may be printed in a different mode from second machine-readable code.

When the controller 21 controls the printer 5 to print multiple machine-readable codes on the slide glass and obtains information on the reading result as availability information, the reading result is obtained by having the reader 7 read the multiple printed machine-readable codes. At this time, if at least one of the machine-readable codes is readable, the first control may be executed, and if all the machine-readable codes are unreadable, the second control may be executed.

### Effect of the Second Embodiment

In this embodiment, multiple machine-readable codes are printed on the slide glass. This increases the likelihood that there will be a machine-readable code less affected by abnormalities in the printer, thereby increasing the possibility of continuing the processing of smear specimens. Therefore, it contributes to both the continuation of smear specimen production and the identification of the slide glass. In this embodiment, the first machine-readable code and the second machine-readable code are printed in different printing modes. This increases the likelihood that there will be a machine-readable code in a printing mode less affected by abnormalities in the printer. Therefore, it contributes to both the continuation of smear specimen production and the identification of the slide glass. In this embodiment, the first machine-readable code and the second machine-readable code are printed at different angles. This increases the likelihood that there will be a machine-readable code printed at an angle less affected by abnormalities in the printer. Therefore, it contributes to both the continuation of smear specimen production and the identification of the slide glass.

### Second Example

In the First Example, the smearing apparatus 1 itself includes the reader 7, and information on the reading result is obtained from the reader 7 as availability information of the machine-readable code. Based on this availability information, the smearing apparatus 1 executes the first control to perform printing on the slide glass SG by the printer 5, or the second control to suspend printing by the printer 5. The smearing apparatus 1 is not limited to such a configuration. As shown in Second Example and Third Example described later, the smearing apparatus 1 may obtain information on the reading result from a reader provided in an external device as availability information. Based on this availability information, the smearing apparatus 1 may perform the first control or the second control.

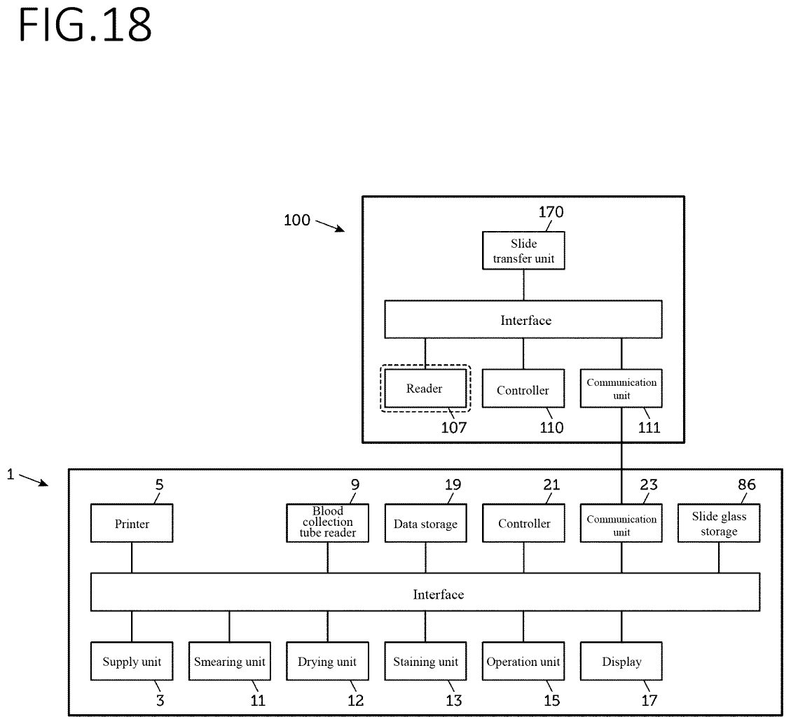

FIG. 18 shows an example in which the reader 7 is not provided in the smearing apparatus 1, and the reader 107 is provided in the slide transport apparatus 100 capable of communicating with the smearing apparatus 1. The reader 107 is installed at a predetermined position of the slide transport apparatus 100, for example, at the slide pickup position P (see FIG. 3). The reader 107 executes reading of the machine-readable code m printed on the picked-up slide glass SG. When the controller 110 of the slide transport apparatus 100 obtains information on the reading result, it transmits the information to the smearing apparatus 1 via the communication unit 111. The controller 21 of the smearing apparatus 1 obtains information on the reading result received from the slide transport apparatus 100 as availability information of the machine-readable code, and based on this availability information, executes the first control or the second control described above.

As described above, even when the smearing apparatus 1 itself, which is equipped with the printer 5, is not provided with the reader 7, the reader 107 is provided in the slide transport apparatus 100, which performs the post-printing process, so that the availability information can be acquired from the reader. The second embodiment may be an example of a smear slide processing system configured by two smear specimen processing apparatuses, namely, the smearing apparatus 1 and the slide transport apparatus 100.

### Third Example

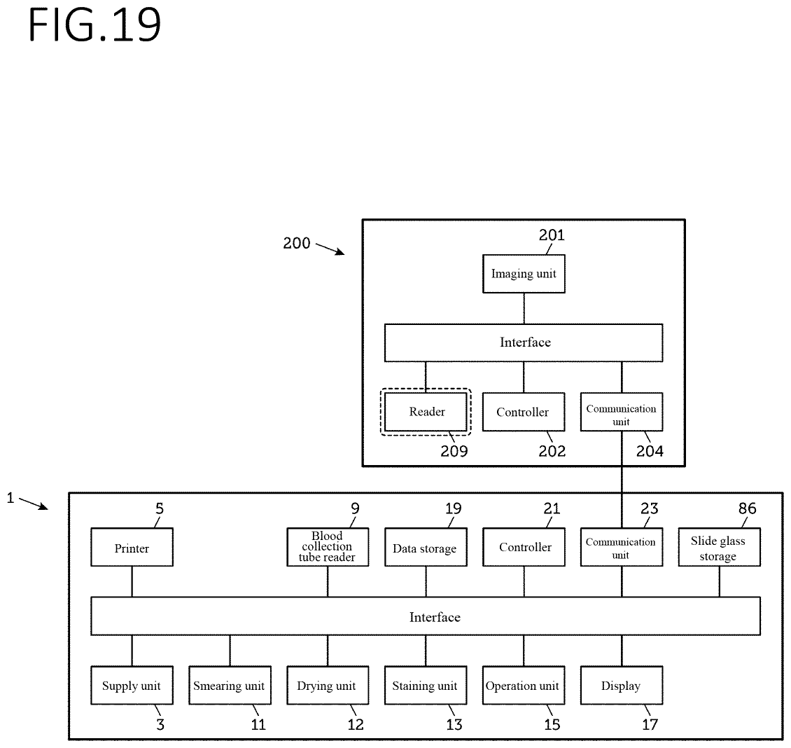

FIG. 19 shows an example in which the reader 7 is not provided in the smearing apparatus 1, and the reader 209 is provided in the imaging apparatus 200 capable of communicating with the smearing apparatus 1. The reader 209 executes reading of the machine-readable code m that is installed at a predetermined position of the imaging apparatus 200, for example, at a position of the imaging unit 201 and printed on a slide glass SG that is an imaging target. The reader 209 may include a camera of the imaging unit 201 or may include a camera different from the camera of the imaging unit 201. When the controller 202 of the imaging apparatus 200 obtains information on the reading result, it transmits the information to the smearing apparatus 1 via the communication unit 204. The controller 21 of the smearing apparatus 1 obtains information on the reading result received from the imaging apparatus 200 as availability information of the machine-readable code, and executes the first control or the second control based on the availability information.

As described above, although the smearing apparatus 1 with the printer 5 is not provided with the reader 7, the reader 209 is provided in the imaging apparatus 200, which performs the post-printing process, so that the availability information can be acquired from the reader. The third embodiment may be an example of a smear slide processing system configured by two smear specimen processing apparatuses, namely, the smearing apparatus 1 and the imaging apparatus 200.

### [Example Regarding the Printing Method]

In the above embodiment, an example in which the printer 5 is a thermal printer has been described. According to the above embodiment, even when an abnormality occurs in the thermal printer, it is possible to prevent the abnormality from affecting the processing of smear specimens.

The printer 5 is not limited to a thermal printer. The printer 5 may print the machine-readable code by another printing method. For example, the printer 5 may be a laser printer.

In a laser printer, for example, laser light scanned by a DMD (Digital Micromirror Device) is focused onto the slide glass SG. The pigment pre-applied to the printing area of the slide glass SG undergoes a chemical change, and the raster data related to the machine-readable code m is printed. For example, if the micromirrors (DMD elements) of the DMD malfunction, defects may occur in the printing results.

In this case, the availability information may be, for example, the malfunction rate of the DMD elements detected by means for detecting the malfunction rate. The controller 21 may receive the malfunction rate of the DMD elements sent from the printer 5. The first control and the second control may be performed in the same manner as in the case of a thermal printer.

The availability information may be only the information on the reading result of the machine-readable code printed on the slide glass SG by the reader 7. In this case, since the information on the reading result can be obtained as availability information regardless of the printing method used for the machine-readable code, the printing method of the printer is not limited.

What is claimed is:

1. A smearing apparatus, comprising:
a printer configured to print a machine-readable code used for identification of a specimen onto a slide glass;
a smearing unit configured to smear the specimen on the slide glass; and
a controller programmed to obtain information indicating an availability of the printer, and to perform, based on the information, a first control to control the printer to print the machine-readable code on the slide glass, or a second control to suspend the printer.

2. The smearing apparatus according to claim 1, wherein
the controller monitors a state of the printer and outputs, according to the state of the printer, an abnormality of the printer to a user.

3. The smearing apparatus according to claim 1, wherein
the machine-readable code is read by a reader provided in the smearing apparatus or the imaging apparatus, and
the information is a result of reading the machine-readable code by the reader.

4. The smearing apparatus according to claim 1, wherein
the printer prints the machine-readable code on the slide glass by pressing heating elements of a thermal printer against the slide glass via an ink ribbon.

5. The smearing apparatus according to claim 4, wherein
the controller is operable to control, in the first control, the printer to print the machine-readable code in a first mode and in a second mode different from the first mode.

6. The smearing apparatus according to claim 5, wherein
the controller controls the printer to print, in the first mode, the machine-readable code at a first position and the controller controls the printer to print, in the second mode, the machine-readable code at a second position.

7. The smearing apparatus according to claim 5, wherein
the controller controls the printer to print, in the first mode, the machine-readable code at a first angle and the controller controls the printer to print, in the second mode, the machine-readable code at a second angle.

8. The smearing apparatus according to claim 5, wherein
the controller controls the printer to print, in the first mode, a first number of machine-readable codes and
the controller controls the printer to print, in the second mode, a second number of machine-readable codes.

9. The smearing apparatus according to claim 1, wherein
the printer prints a first machine-readable code on a first slide glass, and
the controller obtains the information, determines that reading is unsuccessful, and controls the printer to print a second machine-readable code on a second slide glass as the first control.

10. The smearing apparatus according to claim 9, further comprising a reader including a camera, wherein
the reader reads the machine-readable code, and
the controller obtains the information.

11. The smearing apparatus according to claim 10, wherein
the printer prints the machine-readable code on the first slide glass in multiple copies, and
the controller obtains a result of reading the machine-readable codes printed on the first slide glass as the information, determines readability of the machine-readable codes, and executes the first control upon determining that at least one of the plurality of machine-readable codes is readable, and executes the second control upon determining that all of machine-readable codes are unreadable.

12. The smearing apparatus according to claim 1, wherein
the controller detects breakages of the heating elements as the information indicating the availability before printing the machine-readable code on the slide glass by the printer.

13. The smearing apparatus according to claim 12, wherein
the controller detects breakages of the heating elements corresponding to the printing position of the machine-readable code.

14. The smearing apparatus according to claim 13, wherein
the first control is performed based on a number of broken heating elements corresponding to the printing position of the machine-readable code being less than a predetermined number, and
the second control is performed based on the number of broken heating elements being equal to or greater than the predetermined number.

15. The smearing apparatus according to claim 14, wherein
the first control is performed based on a position of the broken heating element corresponding to the printing position of the machine-readable code not being a predetermined position, and
the second control is performed based on the position of the broken heating element being the predetermined position.

16. The smearing apparatus according to claim 15, wherein
the controller outputs an abnormality in response to a predetermined condition being satisfied.

17. The smearing apparatus according to claim 16, further comprising a display unit and an input unit,
wherein the display unit displays information for setting the condition, and
the input unit receives the setting of the condition from the user.

18. The smearing apparatus, comprising:
a printer configured to print a machine-readable code used for identification of a specimen onto a slide glass;
a smearing unit configured to smear the specimen on the slide glass; and
a controller programmed to control the printer to print multiple copies of the machine-readable code.

19. The smearing apparatus according to claim 18, wherein
the multiple copies include a first machine-readable code printed in a first mode and a second machine-readable code printed in a second mode.

20. The smearing apparatus according to claim 19, wherein
the second machine-readable code is printed at an angle different from the first machine-readable code.
